(19) United States
(12) Patent Application Publication
(10) Pub. No.: US 2019/0356502 A1
(43) Pub. Date: Nov. 21, 2019

(54) SYSTEMS AND METHODS FOR REMOTE CONFIGURATION OF A BUILDING CONTROL SYSTEM INTO A BMS BASED SYSTEM

(71) Applicant: Honeywell International Inc., Morris Plains, NJ (US)

(72) Inventors: Ajay N. Nair, Bangalore (IN); Prabhat Ranjan, Bangalore (IN); Sheeladitya Karmakar, Bangalore (IN); Suresh Vemuri, Bangalore (IN); Kamal Mehta, Bangalore (IN); Yogiraj Dattaram More, Olten (CH)

(21) Appl. No.: 15/982,979

(22) Filed: May 17, 2018

(51) Int. Cl. H04L 12/28; H04L 12/24

(52) U.S. Cl. CPC H04L 12/2809; H04L 41/22; H04L 12/2832; H04L 12/2814

(57) ABSTRACT

Methods and systems for remote configuration of a building control system into a BMS based system are disclosed herein. One remote management device allowing a remote user to connect a new or legacy system to a BMS network includes a processor and memory, the memory having executable instructions that execute to receive identification information that allow a user on a user device to access a remote management application, send instructions to the gateway device to initiate a discovery protocol at the gateway device to identify any network devices connected to the gateway device, receive data related to each identified network device from the gateway device and create a device profile for each identified network device, initiate a discovery of origination points protocol to discover all origination points for data that are relevant to a particular device of the identified network devices, and update the device profile for that particular device.

### TECHNICAL FIELD

The present disclosure relates to methods and systems for remote configuration of a building control system into a BMS based system.

### BACKGROUND

Building control systems, as used herein, describe complex systems that control: multiple devices as a group that are associated with a building, multiple groups of devices within a building, or devices of multiple buildings within a campus or devices of multiple buildings dispersed in different locations. Accordingly, when a new or legacy building control system for a site is to be added to a building management system (BMS), which manages one or more of the control settings or operations of the building control system, the setup of this building control system within the BMS can be complex and time consuming.

Currently, there is no existing system which can help a System Integrator (SI) (i.e., a person tasked with the set up of the new or legacy building control system into the BMS) configure the BMS without physically visiting the site that is being controlled by the building control system. This can involve travel to the site, cost for accommodations, time to manually review the system can to determine device types and other device information, and other business costs.

As used herein, a legacy system is one that was installed in a facility previously and may not have the same operating protocol or locations of particular data types stored in the same locations as other sub systems of the BMS system. Legacy systems may be difficult to integrate into BMS systems as they may not communicate information or data, for example, about the status of the legacy system in a way that is understandable by the BMS. In this way, when a legacy system needs to be included in a BMS system, it has traditionally needed to be replaced.

However, more recently, BMS systems have included the ability to communicate with some legacy systems if the type of legacy system is identified and the SI enables the BMS system to communicate with the legacy system.

Further, the information about each device within the system needs to be individually identified by the SI. This process can make each installation take a day of activity for one single gateway, in many instances. For larger sites, for example with 500 gateways or more, such a process can lead to weeks and months of set up time which slows the speed at which the building control system can be integrated into the BMS and has a substantial cost in time for the SI.

Additionally, building control systems can belong to different software platforms with each platform having its own user interface and a user of such a system, in order to accomplish its set up will need to understand this user interface. Accordingly, this work at the site requires a person with skill in the particular building control system (and its user interface) being installed and/or the existing building control system.

For example, Niagara is one of the most popular software programs used for building control. If the building control system is a Niagara system, in order to set up the system with the BMS, under the current process, the installer would have to be a trained Niagara professional who knows how to use the Niagara workbench (Niagara's user interface).

Use of a virtual private network (VPN) to allow the SI to work remotely from the installation site can be accomplished, but for some sites, the VPN connection involves the BMS provider to gain security access, which may take weeks to get clearance, in some instances. Moreover, the VPN experience is not smooth and can cause bottlenecks during implementation.

Also, typically, an equipment installer is trained to install the equipment correctly and is not trained in navigating the user interface or, generally, in the use of the building control system. Accordingly, under the current systems, in order to set up the building control system within the BMS, either the equipment installer needs to be trained to handle any of the many possible building control systems they will encounter, an installer specially trained in a specific building control system needs to be sent to the site, or a set up specialist, such as an SI, (in addition to the equipment installer) needs to the sent to the site.

Moreover, the existing systems do not provide the capabilities to do all configuration operations necessary to set up the building control system within the BMS at a location remote to the site. This also means an SI experienced in the particular building control system being used and/or the particular BMS being used must be physically present on the site, as the set up process involves a lot of technical training to know how to identify information that will be needed during the setup process and to navigate the BMS software.

### BRIEF DESCRIPTION OF THE DRAWINGS

FIG. 1 is an illustration of the components of a remote configuration system that could be used in accordance with embodiments of the present disclosure.

FIGS. 2A-2I illustrate screen shots of a work flow for setting up a building control system in a BMS in accordance with embodiments of the present disclosure.

### DETAILED DESCRIPTION

Methods and systems for remote configuration of a building control system into a BMS based system are disclosed herein. One remote management device allowing a remote user to connect a new or legacy system to a BMS network includes a processor and memory, the memory having executable instructions that execute to receive identification information that allow a user on a user device to access a remote management application, send instructions to the gateway device to initiate a discovery protocol at the gateway device to identify any network devices connected to the gateway device, receive data related to each identified network device from the gateway device and create a device profile for each identified network device, initiate a discovery of origination points protocol to discover all origination points for data that are relevant to a particular device of the identified network devices, and update the device profile for that particular device.

The embodiments of the present disclosure solve all the above issues because an on site installer just needs to install the physical gateway device and leave. Software within the gateway allows the rest of the set up process to be accomplished by an SI remotely through use of a network based remote management application tool (via a wide area network, such as the Internet, or local area network based).

The software of the tool also allows data from the system being connected to the BMS to be provided to the tool (e.g., via the gateway device) to allow the SI to perform the configuration of the building control system into the BMS within minutes.

With embodiments of the present disclosure, the SI can accomplish many operations without having to travel to the site and can setup up many sites in quick succession, allowing the SI's time to be used more efficiently and the building control systems to be integrated into the BMS more quickly allowing the BMS to be utilized more quickly with the newly added building control systems.

With respect to the installer, the embodiments of the present disclosure can provide significant benefits. For example, embodiments allow for the ability to install the gateway device quickly and easily in confined and difficult to reach spaces. This because the installer does not need to spend as much time working on the gateway device when it is installed because the majority of the set up process is handled remotely by the SI rather than the site engineer.

With respect to the facility manager (one type of end user) of the building control system at the site of the gateway device, embodiments of the present disclosure can provide a reduction in the time spent identifying and resolving BMS issues. Automatic updates can be run from the tool wherein the updates can run in the background and reduce on-site staff support. The on-site staff can quickly and accurately find the root-cause of problems and fault diagnosis via the system's communication with the tool.

With respect to the SI, embodiments of the present disclosure can provide the ability of the SI to quickly obtain the required/needed data to have services up and running more quickly than in past processes. The tool can provide a service recommendation based upon identified data being pulled from the site's system.

Embodiments can increase the speed of system configuration and connection to the BMS, thereby allowing for quicker uptime after installation of the gateway device. The tool can quickly and relatively effortlessly consolidate data from controllers to the BMS allowing for an aggregated data approach to system management and fault diagnosis, even from those controllers that are using different operating protocols.

With respect to the building operator (another type of end user) of the building control system, embodiments of the present disclosure can reduce time spent managing a building or multiple buildings(s), can reduce equipment and system downtime at sites, can reduce physical operating costs (e.g., energy, maintenance), and can reduce the complexity and time for training staff in operating the systems.

With embodiments of the present disclosure, the ability to have the SI do all BMS configuration and management remotely at the SI's preferred location (e.g., remote from the site of the gateway device) also avoids any travel or physical presence required at the site. This also allows the site engineer to do the installation of the gateway device with no technical knowledge or building control system protocol (e.g., Niagara protocol) experience.

Advantages to such a tool include allowing the SI to easily perform all BMS configuration such as network setup, addition of devices, alarm configuration, and trend configuration, among other functions. Additionally, the building control system can be integrated into the BMS with the minimum amount of wiring and configuration by using the gateway to act as the link between the building control system components and the BMS.

In short, the embodiments of the present disclosure allow for a less trained site engineer to visit the site, connect the gateway with the cables to the other devices of the building control system and to a link to the BMS via a network (WAN, LAN, etc.), and then can leave the site. The gateway can include software that accesses the BMS via the network and can automatically register the gateway with the BMS with the Internet of things (IoT) type network platform and sends the heartbeat. The IoT network allows many devices within a single facility or many facilities to be controlled by the BMS.

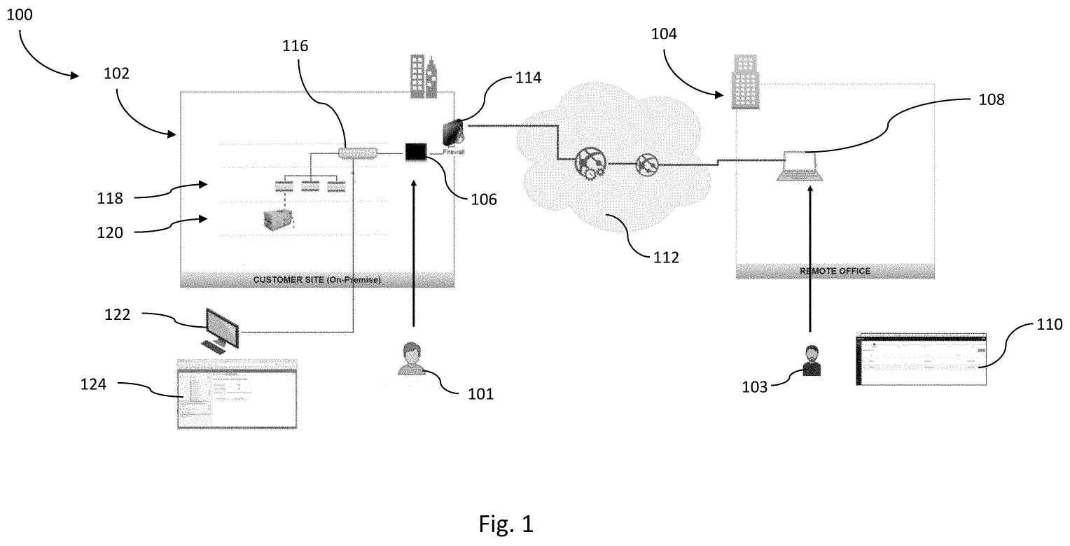

Once contact has been established by the gateway to the BMS, no additional work is required from the site engineer. Once the Gateway starts communicating with the IoT network, the below work flow helps the SI and other users described above to do all the configuration tasks remotely and thus save all the travel cost involved, among the other benefits mentioned herein. FIG. 1 illustrates an example of a system in which embodiments of the present disclosure could be utilized.

In the following detailed description, reference is made to the accompanying drawings that form a part hereof. The drawings show by way of illustration how embodiments of the disclosure may be practiced.

These embodiments are described in sufficient detail to enable those of ordinary skill in the art to practice embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

The figures herein follow a numbering convention in which the first digit or digits correspond to the drawing figure number and the remaining digits identify an element or component in the drawing.

FIG. 1 is an illustration of the components of a remote configuration system that could be used in accordance with embodiments of the present disclosure. FIG. 1 shows a system 100 having a site 102 that has a building control system that is to be added to a BMS and a remote location 104 at which an SI 103 can connect and configure the building control system at 102 to the BMS via a remote management application 110 accessed via a remotely located device 108.

This connection and configuration can be accomplished by communication between a gateway device 106 at site 102 and the remotely located device 108 through an intermediary network 112, such as a WAN, LAN, etc. The communication may also traverse through a firewall 114 provided by a network device at the site 102.

The site 102 also includes a number of network devices. For example, the site 102 includes a network device 116 (e.g., switch, hub, router, etc.) that connects the gateway 106 to other devices within the network.

In some implementations, the gateway can be connected directly to one or more network devices. Network devices also include a number of pieces of connected equipment 120 and a number of controllers 118 that provide functionality to control the operation of the connected equipment.

The building control system is controlled via operating protocol software 124 on a computing device 122. This operating protocol software controls the connected equipment 120 either directly or indirectly (e.g., via controllers 118).

The pieces of connected equipment can each include a number of points from which data can be provided. This data can provide information about a condition at the site 102 (e.g., temperature, humidity, etc.) or the status of the piece of equipment to which the point is associated and/or the status information from other network devices at the site 102.

In the embodiment shown in FIG. 1, the site engineer 101, who can be a laborer not familiar with the operating protocol of the building control system or familiar with the various network devices located at the site (e.g., device types, capabilities, configuration settings, etc.) can install the gateway device 106 during a set up of a new building control system at the site or into a legacy system (e.g., having components 116, 118, 120, 122, and 124, for example). In the embodiment shown in FIG. 1, this installation can be accomplished by connecting the gateway device 106 to the network device 116 (which is connected to all of the other network devices) and to the network 112 that allows the gateway device 106 to communicate with the remote management application 110.

It can be noted from the embodiment shown in FIG. 1, that in the past, the SI would need to be present at the site (e.g., potentially taking the place of the site engineer 101) and would need to configure the building control system from site 102. When done with that configuration, the SI would need to travel to the next site and configure it, and so on until all sites had been set up. In the embodiments of the present disclosure, the SI 103 can stay at the remote location 104 and can remotely connect to and configure multiple sites (similar to 102) in rapid succession.

As discussed herein, there are a number of embodiments that can be utilized to accomplish the concepts disclosed herein. For example, in one embodiment, a remote management device (e.g., a WAN server or can also be located on user device 108) allowing a remote user 103 to connect a new or legacy system at a site 102 to a BMS network 112 includes a processor and memory. The memory having executable instructions that execute to provide a user using a user device 108 access to a remote management application 110, receive a selection of a gateway device 106 that needs to be connected to the BMS network 112.

The device further includes instructions to initiate a connection to the gateway device 106, send instructions to the gateway device 106 to initiate a discovery protocol at the gateway device 106 to identify any network devices 118, 120, connected to the gateway device. In some embodiments, initiating a connection to the gateway device includes adding a local network reference to a local network database. For example, a local network reference can be a reference to a BACnetNetwork, SBCNEtwork, LON Network, or other suitable network type and the local network database can, for example, be a local Niagara database.

The device includes instructions to receive data related to each identified network device 118, 120 from the gateway device 106 and create a device profile for each identified network device.

The executable instructions can also display a list of the identified network devices on a display component (e.g., a display of computing device 108). Instructions can also be executed to initiate a discovery of origination points protocol that sends instructions to the gateway device to discover all origination points for data that are relevant to a particular device of the identified network devices and update the device profile for that particular device in memory.

In some embodiments, a first particular device in the identified network devices has a first operating protocol and a second particular device in the identified network devices has a second operating protocol and wherein the remote management device receives information about the operating protocols and includes configuration settings that can be used with devices of each of several operating protocols. This can be beneficial in buildings or complexes where devices having different operating protocols can be added to the BMS. In such an embodiment the remote management device can, for example, select configuration settings to be sent to the gateway device based on the operating protocol of the particular device to which the configuration settings are to be installed.

In some embodiments, the remote management application can be used to create configuration settings for a particular device and update the device profile with the configuration settings. These setting can then be sent to gateway device.

For example, the configuration settings include one or more alarm, trend, or facet configuration settings. Alarm settings can be used as an alert to draw attention to an issue with a condition being monitored in the facility or the status of a network device. Trend settings can be used to monitor trends in device performance and can be used to adjust the operation of the device to improve its performance. Facet settings can be used to select the features of the device that are to be used. This can be accomplished for example by having the alarm, trend, or facet configuration settings include settings to forward alarm, trend, or facet information to the gateway for forwarding to the remote management device.

In some embodiments, the remote management application can have a security functionality such that the identification of the user can be confirmed. For example, the device can include instructions to receive identification information that allow a user on a device connected to the remote management device to access a remote management application that is stored in memory and to authorize the user to access the remote management application. In such embodiments, the identification information can, for example, include an identifier of the user using the user device and the identifier of the user using the user device can include a user name and password, among other security measures.

The remote management device can also include instructions to receive a heartbeat signal from the gateway device which can aid in locating the gateway device after it has been installed, but before it has been connected to the remote management application. In such an embodiment, the heartbeat signal includes information regarding the identification of the gateway device.

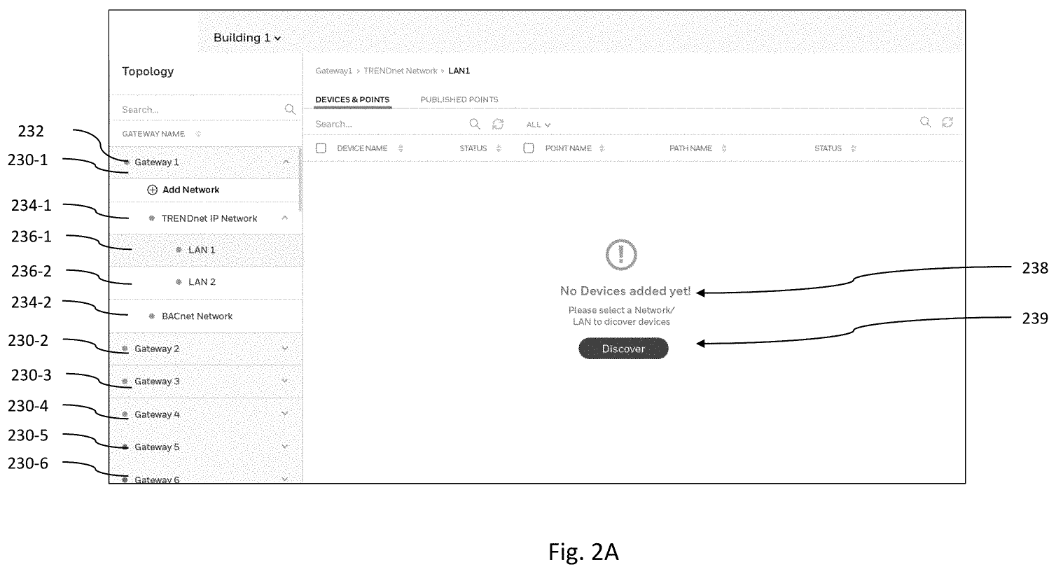

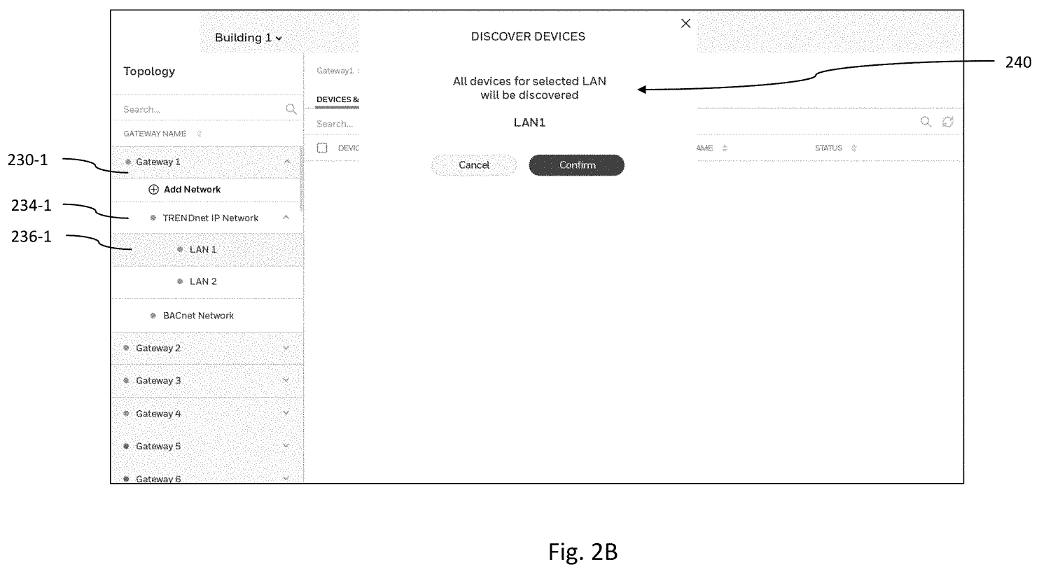

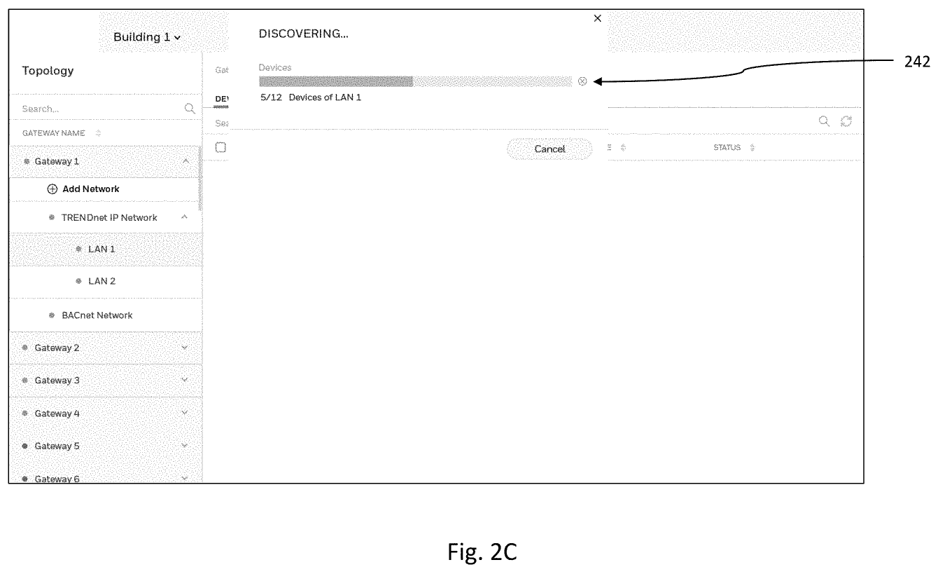

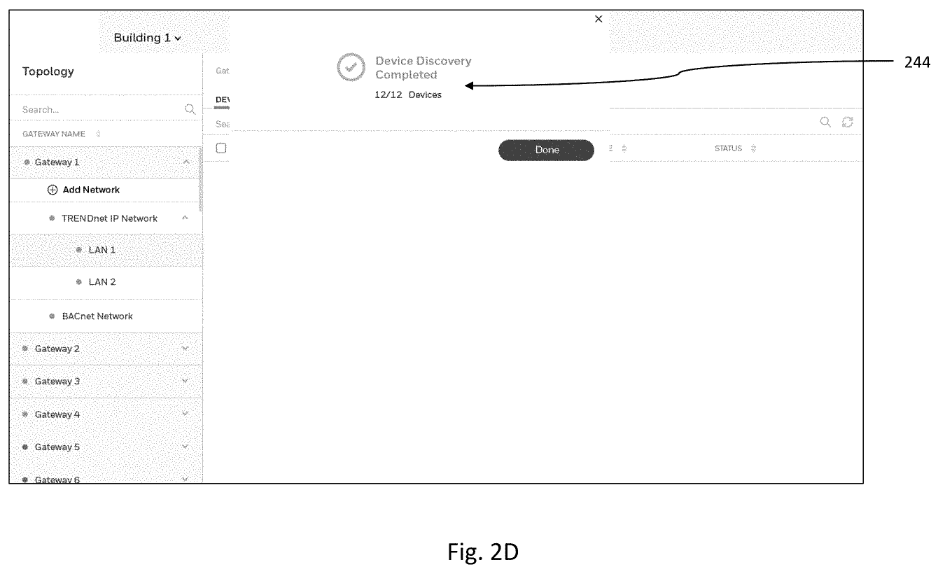

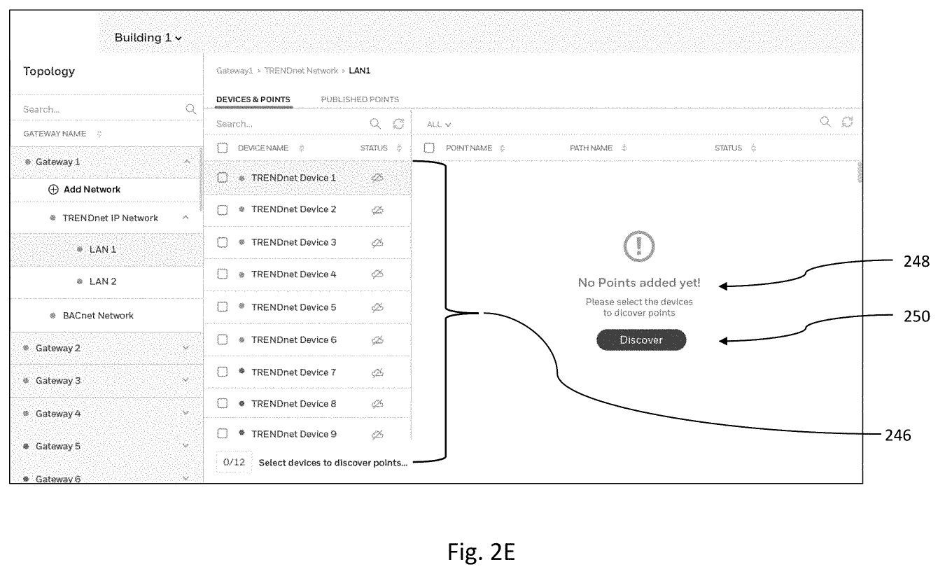

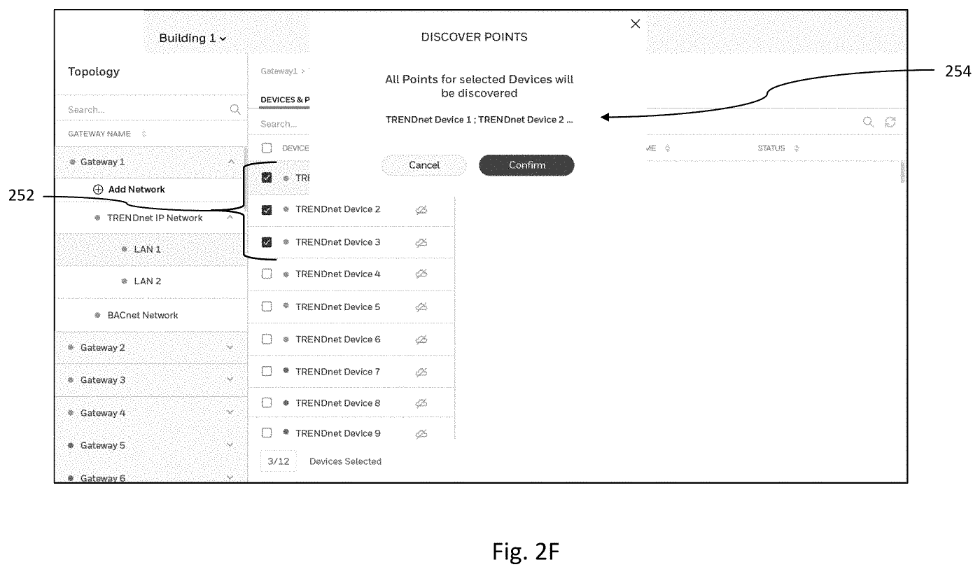

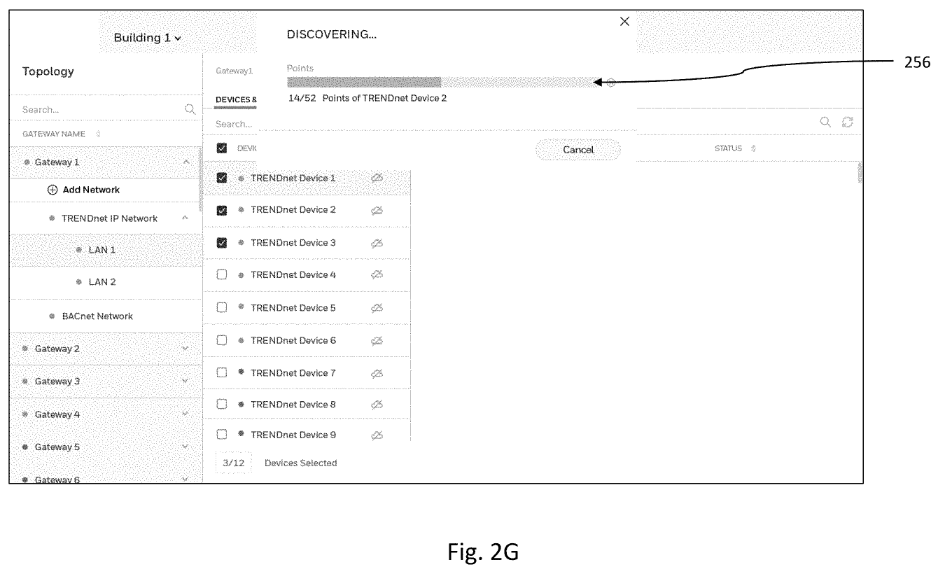

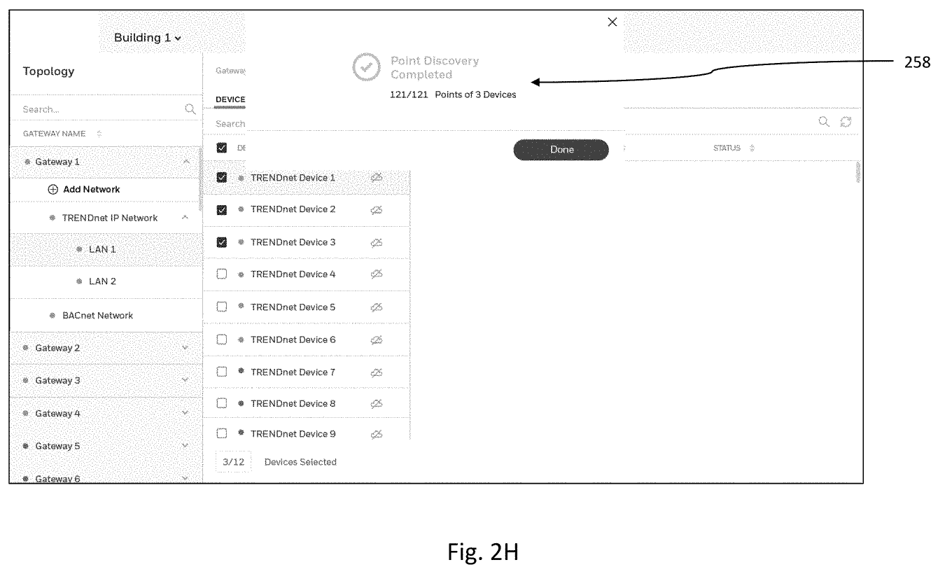

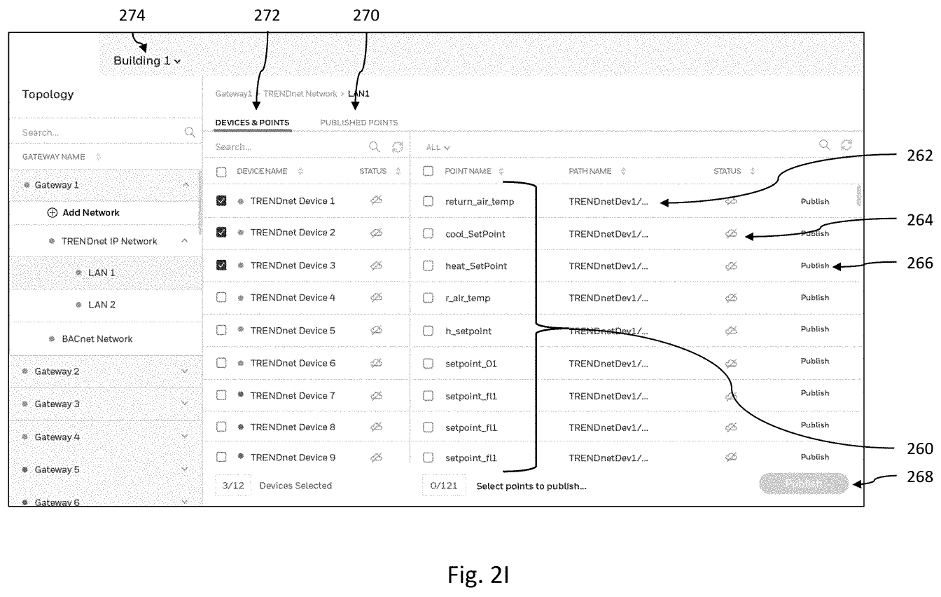

FIGS. 2A-2I illustrate screen shots of a work flow for setting up a building control system in a BMS in accordance with embodiments of the present disclosure. FIG. 2A illustrates an embodiment of a user interface that could be used by an SI to connect and configure a building control system within a BMS. In this screen capture, on the left side is a column that allows the user to select different portions of the system in more detail in the area to the right.

In this example, the user has selected to view gateway 1 identified at 230-1. The status of each component of the system can be indicated by an identifier 232, shown in FIG. 2A as a colored dot (the dots of gateways 1, 2, 3, and 4 are green indicating they are operational whereas the dots of gateways 5 and 6 are red indicating they are not operational). Any suitable indicator may be used to indicate the status of the components of the system.

Gateway 1 has been selected by the user and, as such, information about two network types 234-1 and 234-2 are shown. In the example of FIG. 2A, the network types are a BACnet and a TRENDnet, though the embodiments herein are not so limited.

The user has also selected network 234-1 and two networks are shown, 236-1 and 236-2 (e.g., LAN or other networks). Within network 234-1, the user has selected network 236-1. Once the user has made these selections, the user interface area to the right shows all of the information about that component of the system that is known by the BMS. As can be seen from the example of FIG. 2A, the information regarding the identification of the gateway device (e.g., Gateway 1, having multiple network types and networks) can be included in a list of devices available for connection to the BMS network from which the user selects the gateway device that needs to be connected to the BMS network.

In the example shown in FIG. 2A, the area to the right side has a statement that no devices have been added yet, indicating that the user has some system configuration to do with respect to the network of gateway 1. The area also includes a discover button at 239. This button can be clicked by the user to initiate a discovery functionality to discover network devices as will be discussed in more detail below.

In FIG. 2B, the discovery functionality (also referred to herein as a discovery protocol) has been initiated and discovery of network devices connected to gateway 1 230-1 for the first network type 234-1 and first network 236-1 will be discovered. The right side area of the user interface includes a note stating that: all devices for selected LAN will be discovered and identifies that LAN 1 236-1 has been selected by the user.

FIG. 2C shows a progress bar 242 for the discovery process in the right side area of the user interface. The discovery process can be accomplished by having instructions stored in memory associated with the remote management application execute to send instructions to the gateway device to initiate a discovery process. For example, a remote configuration engine executes a system command remotely (this can be run in a cloud location) and is used to trigger an API (e.g., a Niagara API) in the gateway device. This executes a query on the LAN (via the gateway device) to probe the LAN for devices and points and sends messages back to the remote configuration engine that keeps track of the devices and points. At the gateway device, the discovery process can, for example, be accomplished by sending ping messages to all devices connected via LAN 1. As used herein network devices are, for example, any heating or cooling device connected to the LAN of a heating and cooling system to be added. Network devices can be building automation controls (BACnet), local operating network (LON), Modbus, Trend Control Systems, SBC, Centreline, or other device types communicating within the system. FIG. 2D shows an indication that the device discovery process has been completed and indicates that 12 devices have been discovered.

FIG. 2E shows the 12 devices listed out in a column on the right side of the user interface. These 12 device listings represent separate device profiles for each device that allow additional information to be associated with the device. The right side of the user interface also includes a note that states that no points have been added yet and that the user needs to select particular devices from the list to be searched for points at 248 and a button 250 to initiate the discovery on the points for the devices selected by the user.

As used herein, points are types of data that can be obtained about a device. For example, outside air temperature, supply temperature, boiler status, cool set point are some of the many types of points that can be obtained from one or more devices of a heating and cooling system. They can include points for identifying sensor data, status condition data, and set point data, among other information that will be used to control the overall system being added.

In the illustration of FIG. 2F, the user has selected the first three devices 252 identified in the discovery of devices process of FIGS. 2D and 2E. The area on the right side of the user interface includes a statement that all points for the selected devices will be discovered.

FIG. 2G shows a progress bar 256 for the discovery process in the right side area of the user interface. The discovery process (also referred to herein as a discovery of origination points protocol) can be similar to that described above with respect to the discovery of the devices except that the gateway device sends instructions to the network devices requesting information about the points the network device has associated with it. FIG. 2H shows an indication that the device discovery process has been completed and indicates that 121 points associated with the three selected devices have been discovered.

In FIG. 2I the right side of the user interface has the points listed out at 260. The location of the point in memory associated with the remote management application is shown at 262. Although any suitable naming convention can be user, the structure of the naming of the memory location shown in FIG. 2I also indicates the device to which the point is related (e.g., the pathname includes TRENDnet Dev1). This area of the user interface also includes the status of whether the point information has been published to memory (in FIG. 2I a crossed out cloud symbol indicates at 264 that the information has not yet been published to the BMS system and thereby stored in the BMS memory).

Publishing the information can be accomplished, for example, by selecting a particular point to publish at 266 or selecting all of the points and selecting the publish button at 268. It should be noted that the screen shots provided in FIGS. 2A-2I show a view on the user interface of the devices and points tab 272 which shows all devices and points. There is also a published points tab at 270 that, when selected, only shows those points that have been published.

Another feature shown in FIG. 2I is a field 274 for selection of a building (in the example, building 1 is selected). This feature allows the user to quickly switch from one building to another. In prior processes, switching buildings meant physically moving from one building to another, so the embodiments of the present disclosure offer significant benefits in that regard.

The user interface can also have a selector, similar to that shown for the building selection, that can be used to select a location (e.g., where the SI is connecting and configuring a group of devices at a first location and then switching to another location having a different group of devices. Likewise, this is a much faster way to move from the set up at one location to another.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A remote management device allowing a remote user to connect a new or legacy system to a BMS network, comprising:
a processor and memory, the memory having executable instructions that execute to:
provide a user using a user device access to a remote management application;
receive a selection of a gateway device that needs to be connected to the BMS network;
initiate a connection to the gateway device;
send instructions to the gateway device to initiate a discovery protocol at the gateway device to identify any network devices connected to the gateway device;
receive data related to each identified network device from the gateway device and create a device profile for each identified network device;
display a list of the identified network devices on a display component;
initiate a discovery of origination points protocol that sends instructions to the gateway device to discover all origination points for data that are relevant to a particular device of the identified network devices; and
update the device profile for that particular device in memory.

2. The device of claim 1, initiating a connection to the gateway device includes adding a local network reference to a local network database.

3. The device of claim 2, wherein local network reference is a reference to a BACnetNetwork, SBCNEtwork, or LON Network.

4. The device of claim 3, wherein local network database is a local Niagara database.

5. The device of claim 1, wherein a first particular device in the identified network devices has a first operating protocol and wherein a second particular device in the identified network devices has a second operating protocol and wherein the remote management device receives information about the operating protocols and includes configuration settings that can be used with devices of each of several operating protocols.

6. The device of claim 5, wherein the remote management device selects configuration settings to be sent to the gateway device based on the operating protocol of the particular device to which the configuration settings are to be installed.

7. A remote management device allowing a remote user to connect a new or legacy system to a BMS network, comprising:
a processor and memory, the memory having executable instructions that execute to:
provide a user using a user device access to a remote management application;
receive a selection of a gateway device that needs to be connected to the BMS network;
initiate a connection to the gateway device;
send instructions to the gateway device to initiate a discovery protocol at the gateway device to identify any network devices connected to the gateway device;
receive data related to each identified network device from the gateway device and create a device profile for each identified network device;
display a list of the identified network devices on a display component;
initiate a discovery of origination points protocol that sends instructions to the gateway device to discover all origination points for data that are relevant to a particular device of the identified network devices;
update the device profile for that particular device in memory;
create configuration settings for the particular device and update the device profile with the configuration settings; and
send the configuration settings to the gateway device.

8. The device of claim 7, wherein the configuration settings include one or more alarm configuration settings.

9. The device of claim 8, wherein the alarm configuration settings include settings to forward alarm information to the gateway for forwarding to the remote management device.

10. The device of claim 7, wherein the configuration settings include one or more trend configuration settings.

11. The device of claim 10, wherein the trend configuration settings include settings to forward trend information to the gateway for forwarding to the remote management device.

12. The device of claim 7, wherein the configuration settings include one or more facet configuration settings.

13. The device of claim 7, wherein a first particular device in the identified network devices has a first operating protocol and wherein a second particular device in the identified network devices has a second operating protocol and wherein the remote management device receives information about the operating protocols and includes configuration settings that can be used with devices of each of several operating protocols.

14. The device of claim 13, wherein the remote management device selects configuration settings to be sent to the gateway device based on the operating protocol of the particular device to which the configuration settings are to be installed.

15. A remote management device allowing a remote user to connect a new or legacy system to a BMS network, comprising:
a processor and memory, the memory having executable instructions that execute to:
receive identification information that allow a user on a device connected to the remote management device to access a remote management application that is stored in memory;
authorize the user to access the remote management application;
receive a selection of a gateway device that need to be configured for connection to the BMS network;
initiate a connection to the gateway device;
send instructions to the gateway device to initiate a discovery protocol at the gateway device to identify any network devices connected to the gateway device;
receive data related to each identified network device from the gateway device and create a device profile for each identified network device;
display a list of the identified network devices on a display component;
initiate a discovery of origination points protocol that sends instructions to the gateway device to discover all origination points for data that are relevant to a particular device of the identified network devices;
update the device profile for that particular device in memory;
create configuration settings for the particular device and update the device profile with the configuration settings; and
send the configuration settings to the gateway including instructions to install the configuration setting on the particular device by the gateway device.

16. The device of claim 15, wherein the identification information includes an identifier of the user using the user device.

17. The device of claim 16, wherein the identifier of the user using the user device includes a user name and password.

18. The device of claim 15, wherein the remote management device also includes instructions to receive a heartbeat signal from the gateway device.

19. The device of claim 18, wherein the heartbeat signal includes information regarding the identification of the gateway device.

20. The device of claim 15, wherein the information regarding the identification of the gateway device is included in a list of devices available for connection to the BMS network from which the user selects the gateway device that needs to be connected to the BMS network.
